(19) United States
(12) Patent Application Publication
(10) Pub. No.: US 2012/0088506 A1
(43) Pub. Date: Apr. 12, 2012

(54) METHOD FOR OPERATING A NETWORK AND A NETWORK

(75) Inventors: Jun Zhou, London (GB); Linghang Fan, Surrey (GB); Nader Zein, London (GB)

(73) Assignee: NEC EUROPE LTD., Heidelberg (DE)

(21) Appl. No.: 13/259,200

(22) PCT Filed: Apr. 23, 2010
(86) PCT No.: PCT/EP2010/002516

§ 371 Date: Nov. 29, 2011

(30) Foreign Application Priority Data
Apr. 23, 2009 (EP) 09251165.8

(51) Int. Cl. H04W 24/02; H04W 72/04; H04W 36/00

(52) U.S. Cl. 455/436; 455/422.1; 455/450

(57) ABSTRACT

For allowing a reliable communication within a network by simple constructive features a method for operating a network is claimed, wherein a number of base stations are grouped into a cluster and are connected to a cluster controller and wherein the cluster controller is providing access of the base stations to a main network. The method is characterized in that the cluster controller is mitigating interference within and/or outside the cluster on the basis of a measurement information and/or report from at least one base station. Further, an according network is claimed, preferably for carrying out the above mentioned method.

The present invention relates to a method for operating a network, wherein a number of base stations are grouped into a cluster and are connected to a cluster controller and wherein the cluster controller is providing access of the base stations to a main network. Further, the present invention relates to a network, wherein a number of base stations are grouped into a cluster and are connected to a cluster controller and wherein the cluster controller is designed for providing access of the base stations to a main network.

Networks comprising a number of base stations which are grouped into a cluster are widely known. For example, from “Data Sheet of IntelliNet Femtocell Controller”, www.intellinet-tech.com, is obtainable an arrangement of femtocell base stations which are connected to a cluster controller wherein the cluster controller is providing access of the base stations to a main network, such as an IP network.

Femtocell, for example, is a technology that allows users to install small base stations in indoor environment using licensed spectrum in order to increase coverage and/or throughput, see 3GPP TS22.220 “Service requirements for Home NodeBs and Home eNodeBs”, Release 9, V9.0.0 (2009-03). In most cases, the femtocell base stations are installed in isolation and they are connected to the network via a broadband connection such as ADSL (Asymmetric Digital Subscriber Line). This method has many drawbacks. For example, an individual femtocell can only service a small area which is covered by radio links; it is difficult to mitigate the inference from other femtocell/macrocell base stations/mobile stations. The power and resource allocation in femtocell environment is complex. So does the handover between femtocells sharing same neighborhood such as private enterprise premises, Mall, office building etc. In such environment all traffic between these femtocells needs to be diverted to the backbone network.

“Clustering” is an efficient method to group base stations, see NTT DOCOMO INC, AU000004882300A, “Cluster structured mobile communication system, base station, cluster control station, line control station and mobile station”. Recently, a new state of the art technique called “femtocell cluster” has been proposed, see the above mentioned Data Sheet of IntelliNet, to connect a group of femtocell BSs (Base Stations) to an IP-PBX (Internet Protocol Private Branch Exchange) or femto cluster controller, who acts as the interface/gateway between the femtocells clusters and the outside world. In comparison with the isolated-installed-femtocell solution this method has several advantages: For example, it can cover a larger area with support for soft handover; and traffic to backbone will reduce.

However, this state of the art has some drawbacks: The interference mitigation, which is very important in the femtocell, especially in the high density deployment, was not considered or remained complicated for both distributed and centralized approaches; furthermore, the resource and power allocation is still complex. This will result in a low communication quality within the network.

It is an object of the present invention to improve and further develop a method for operating a network and an according network for allowing a reliable communication within the network by simple constructive features.

In accordance with the invention, the aforementioned object is accomplished by a method comprising the features of claim 1 and a network comprising the features of claim 12.

According to claim 1 the method is characterized in that the cluster controller is mitigating interference within and/or outside the cluster on the basis of a measurement information and/or report from at least one base station.

According to claim 12 the network is characterized in that the cluster controller is comprising means for mitigating interference within and/or outside the cluster on the basis of a measurement information and/or report from at least one base station.

According to the invention it has been recognized that it is possible to enhance the communication quality within the network by simply extending the functionalities of a cluster controller. In concrete terms the cluster controller is mitigating interference within and/or outside the cluster on the basis of a measurement information and/or report from at least one base station. After having received the above information and/or report the cluster controller can start activities for mitigating interference within and/or outside the cluster. By installing such a functionality within the cluster controller the design of base stations can be simplified. Thus, the costs of base stations can be kept low.

Thus, a method for operating a network and an according network allowing a reliable communication within the network by simple constructive features are provided.

Within a concrete preferred embodiment the base stations could be femtocell base stations and the cluster controller could be a femtocell cluster controller.

Within a preferred embodiment the cluster controller could mitigate interference among mobile stations and/or base stations and/or femtocell base stations and/or macrocell base stations. Such a mitigation of interference is also possible among groups of stations which are comprising different types of the above mentioned types of stations.

The cluster controller can use various interference mitigation techniques to reduce the interference among stations. Preferably, a technology for mitigating interference used by the cluster controller could comprise beam forming and/or power control and/or spectrum avoidance. The concrete used technology could be dependent from the respective use case.

For providing simply designed base stations the cluster controller could comprise the functionalities of Radio Resource Management (RRM) and/or traffic control and/or handover within the cluster and/or handover between cluster and main network and/or other radio network. Thus, important intelligent functionalities could be realized within the cluster controller.

A preferred method for mitigating interference could comprise a step wherein the cluster controller—preferably periodically—sends an information and/or a report request to at least one of the base stations. Within a preferred embodiment the cluster controller could send such a request to many or all base stations.

In a next step the base station or base stations could perform a measurement on its radio channel or channels for obtaining channel quality information, preferably SINR (Signal-to-Noise plus Interference Ratio). In other words, the base station or base stations could collect operating information on its own responsibility for use by the cluster controller.

Thus, the base station or base stations could send the measurement information and/or report to the cluster controller for further proceeding within the interference mitigation process.

Preferably, the base station or base stations could additionally send frequency reuse parameters to the cluster controller for use within and enhancing the quality of the interference mitigation process.

Based on the received information and/or report the cluster controller could now allocate resource to the base station or base stations. Additionally, the cluster controller could inform the base stations about the allocated resource. Thus, a reliable communication within the network could be realized by simple features.

For realizing a centralized design of the network the cluster controller could be collocated with a gateway, preferably femtocell gateway, for providing access of the base stations to the main network. By such a collocation of cluster controller and gateway it is possible for a network operator to own and/or manage both components—cluster controller and gateway—in a very simple way.

Within a further preferred embodiment of the network a number of cluster controllers could be connected to one gateway, preferably femtocell gateway. Such an embodiment could enable the integration of many base stations within the control area of one cluster controller.

As a preferred use case the network could be realized in a preferably large corporation deployment or in a high-density residential deployment area. However, other use cases are possible.

Within the claimed network the base stations could be positioned not far away from the cluster controller. However, within a preferred embodiment it could be possible that the base stations are positioned far away from the cluster controller. Thus, the base stations could be connected to the cluster controller via logical connections or via VPN (Virtual Private Network). This would simplify interference management and traffic management.

Based on the inventive method for operating a network and the inventive network the above-mentioned problems resulting form current methods can be solved. According to an important aspect, for example, femtocell base stations are connected to a local femtocell cluster controller, and within the femtocell cluster, the local femtocell cluster controller not only has the possible functionalities of RRM, traffic control, and handover within the femtocell cluster, but also can mitigate the interference within and/or outside the femto cluster. Based on the measurement information and/or report, the femtocell cluster controller can use various interference mitigation techniques to reduce the interference among mobile stations, femtocell base stations and macrocell base stations. These technologies may include beam forming, power control, spectrum avoidance, etc.

There are several ways how to design and further develop the teaching of the present invention in an advantageous way. To this end, it is to be referred to the patent claims subordinate to patent claims 1 and 12 on the one hand and to the following explanation of preferred examples of embodiments of the invention, illustrated by the drawing on the other hand. In connection with the explanation of the preferred embodiments of the invention by the aid of the drawing, generally preferred embodiments and further developments of the teaching will be explained. In the drawing

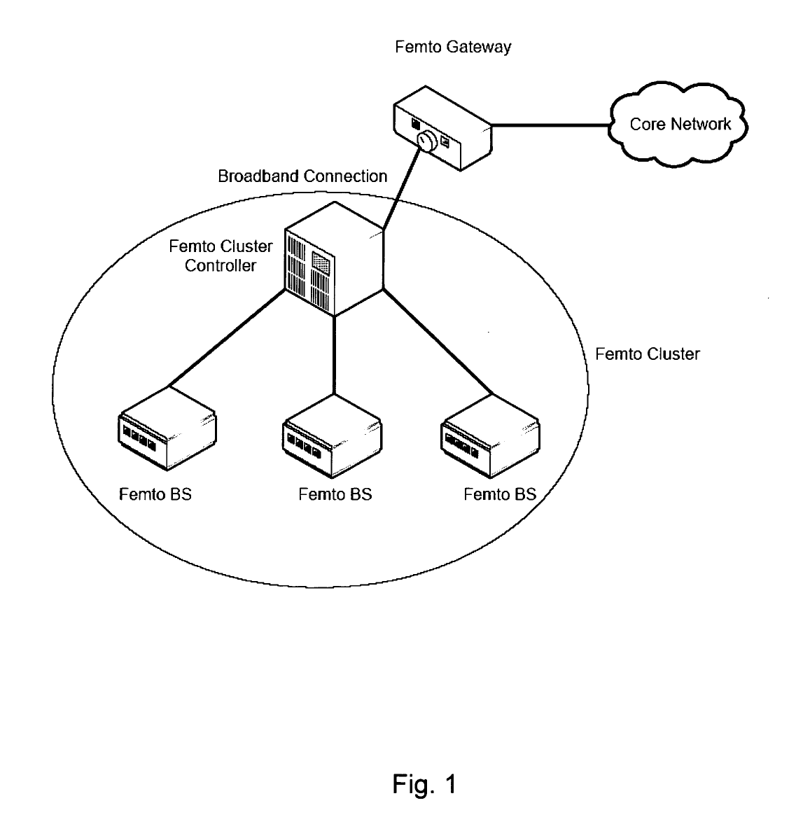

FIG. 1 is illustrating a first preferred embodiment of a network according to the invention,

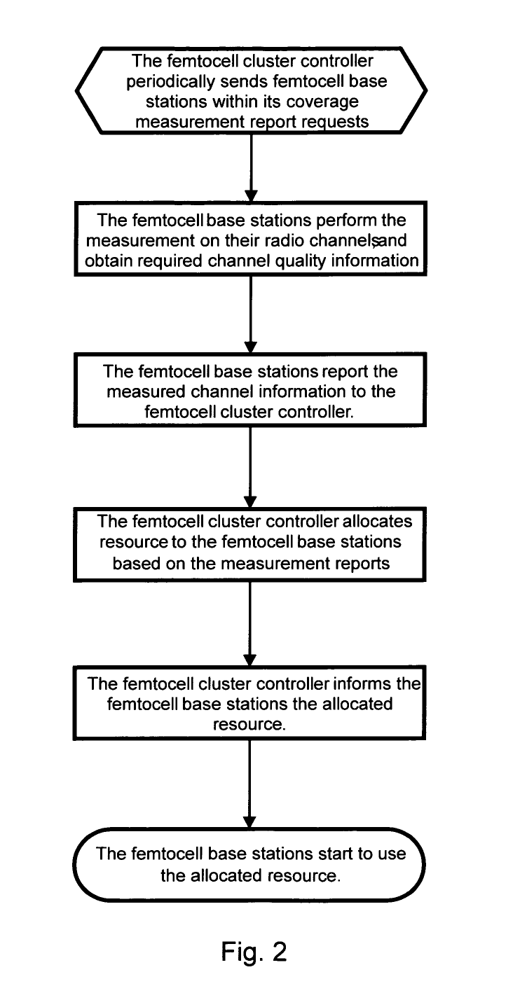

FIG. 2 is illustrating within a flow chart the interference mitigation in a femtocell cluster according to an embodiment of the present invention,

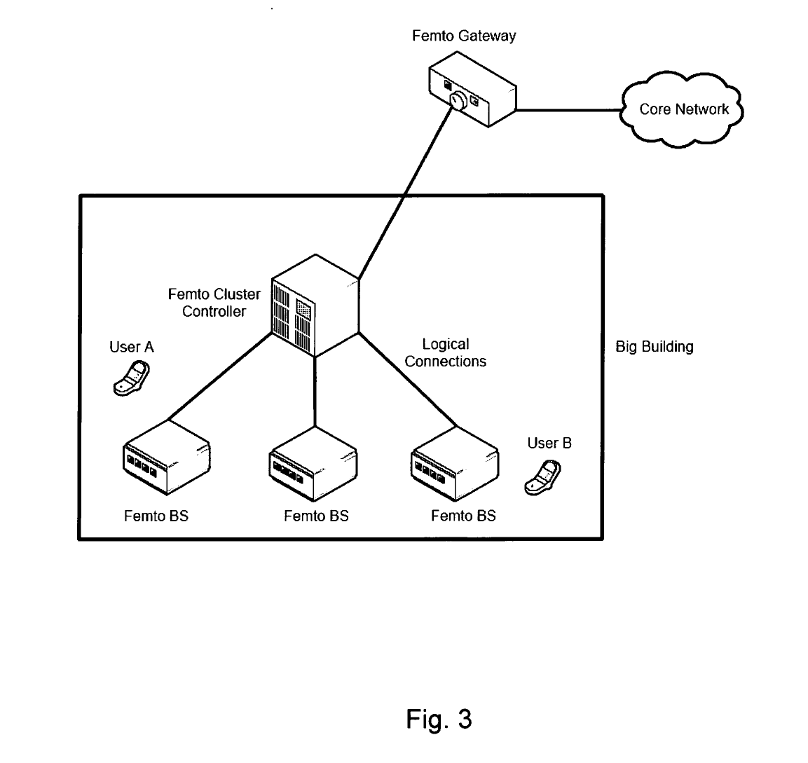

FIG. 3 is illustrating a second embodiment of a network according to the invention,

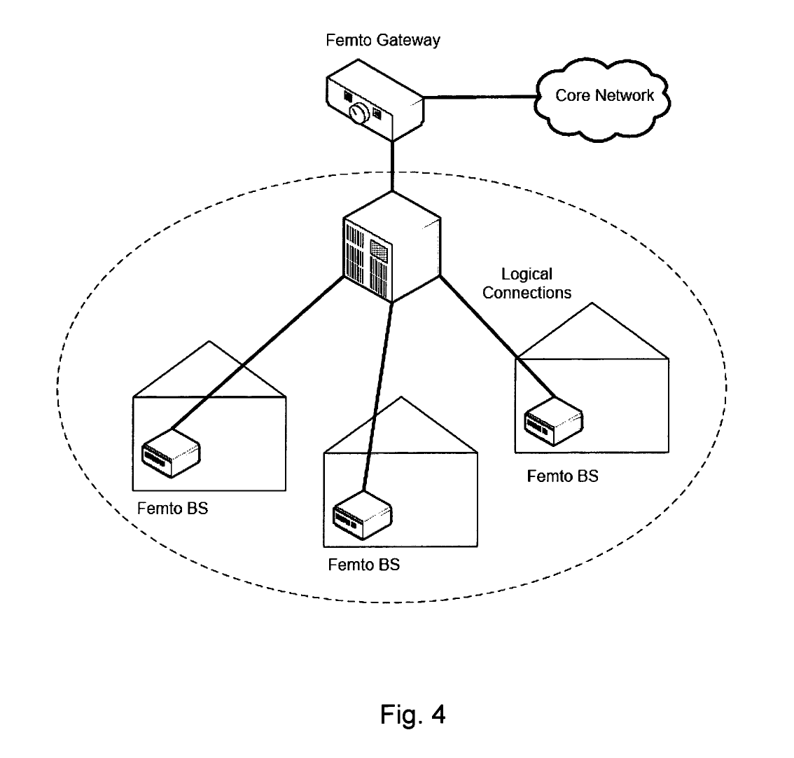

FIG. 4 is illustrating a third embodiment of a network according to the invention and

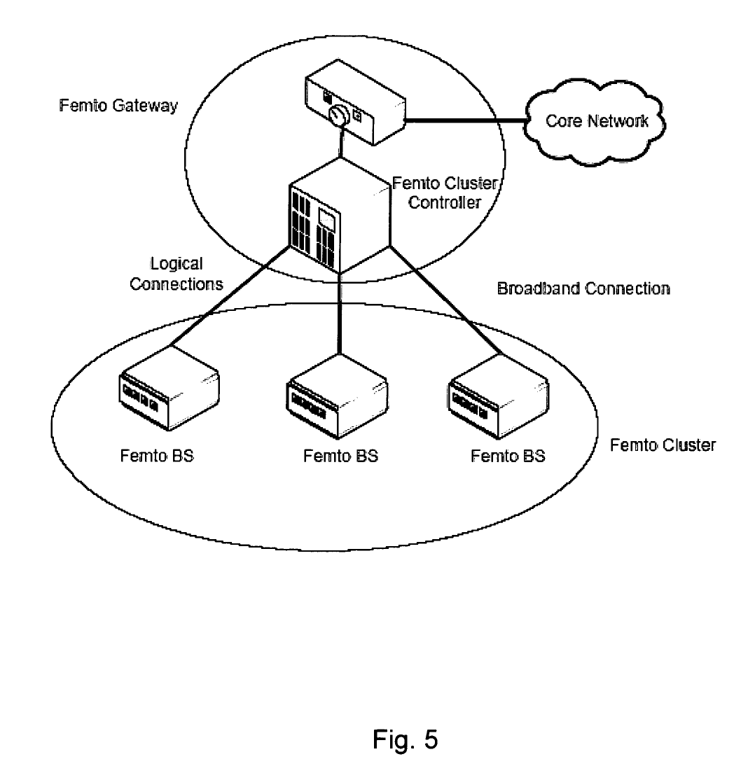

FIG. 5 is illustrating a fourth embodiment of a network according to the invention.

FIG. 1 is illustrating a first embodiment of a network according to the invention. FIG. 1 is showing the architecture of a femto cluster with a femto cluster controller. Three femtocell base stations BS are connected to the femto cluster controller for providing a femto cluster. The femto cluster controller is connected to a femto gateway by a broadband connection. The femto gateway is providing access to a core network or main network.

FIG. 2 is illustrating within a flow chart the interference mitigation in a femtocell cluster according to a preferred embodiment of the invention. As shown in FIG. 2, there are six steps for the interference mitigation in the femtocell cluster:

Step 1: The femtocell cluster controller periodically sends to femtocell base stations within its coverage measurement report requests.

Step 2: The femtocell base stations perform the measurement on their radio channels, and obtain required channel quality information, such as SINR.

Step 3: The femtocell base stations report the measured channel information to the femtocell cluster controller. Other Information, such as frequency reuse parameters, may also be sent to the femtocell cluster controller.

Step 4: The femtocell cluster controller allocates resource to the femtocell base stations based on the measurement reports. This is a critical step in the interference mitigation. A simple solution is to use power control to mitigate the inference.

Depending on the scenarios, other interference mitigation techniques, such as beam forming and spectrum avoidance, can be applied.

Step 5: The femtocell cluster controller informs the femtocell base stations about the allocated resource, such as transmission power level, frequency reuse zone, carrier frequencies, and set of subchannels.

Step 6: The femtocell base stations start to use the allocated resource.

Use cases
1.) Femtocell cluster in a large corporation deployment

A femtocell cluster is ideal for large corporation deployment, in which several femtocells are connected to a femtocell cluster controller. In this scenario, illustrated in FIG. 3, user A can move freely within his corporation and enjoys seamless handover between femtocells. The traffic between user A and user B can be established without being routed through the core network. The femtocell cluster controller can optimize the RRM and efficiently mitigate the interference among femtocells.
2.) Femtocell cluster in the high-density residential deployment area

In this scenario, individual neighboring femtocells, which are installed in different homes, are connected to the femtocell cluster controller to form a femtocell cluster. Since the high density of the femtocells, the proposed method can improve the RRM and interference condition for these femtocells. An embodiment of this scenario is illustrated in FIG. 4.
3.) Femtocell cluster controller collocated with femtocell Gateway

This scenario, illustrated in FIG. 5, includes all the above use cases but with the Femtocell cluster controller being collocated with the Femtocell Gateway, and hence assumed to be owned by the network operator. In this femtocell gateway design, it may have the interference mitigation function, and one femtocell gateway is connected to several femtocell base stations. However, in the proposed method, one gateway can have several femtocell cluster controllers, and each femtocell cluster controller is connected to a femtocell cluster, who has several femtocell base stations.

The local femtocell cluster controller can do the centralized optimization of interference mitigation within and outside the femto cluster.

The local femtocell cluster controller according to a preferred embodiment of the invention not only has the functionalities of interference mitigation within and/or outside the femto cluster, but also includes Radio Resource Management (RRM), enhanced soft handover within Femto cluster, and enable the handover between Femto cluster and other radio network, such as macrocell, other isolated Femto, Femto cluster, etc.

Based on the measurement information/reports, the femtocell cluster controller can use various interference mitigation techniques to reduce the interference among mobile stations, femtocell base stations and macrocell base stations. These technologies may include beamforming, power control, spectrum avoidance, etc.

The method and network according to the invention can efficiently mitigate the interference among femtocells and macrocells. Further, an optimization of power and resource managements is provided.

In comparism to the isolated femtocell solution, which is normally used in a residential home, the proposed approach can cover a large area, such as a shopping mall or a large residential area. The work load of a network controller can be reduced.

Since some intelligent functionalities, such as RRM and interference management, can be moved from femtocell base stations to the femtocell cluster controller, the present invention can simplify the design of femtocell base stations, and therefore can significantly reduce the costs of femtocell base stations. Further, the complexity of femtocell gateways can be reduced.

Many modifications and other embodiments of the invention set forth herein will come to mind the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method for operating a network, wherein a number of base stations are grouped into a cluster and are connected to a cluster controller and wherein the cluster controller is providing access of the base stations to a main network, characterized in that the cluster controller is mitigating interference within and/or outside the cluster on the basis of a measurement information and/or report from at least one base station.

2. A method according to claim 1, wherein the base stations are femtocell base stations and wherein the cluster controller is a femtocell cluster controller.

3. A method according to claim 1, wherein the cluster controller is mitigating interference among mobile stations and/or base stations and/or femtocell base stations and/or macrocell base stations.

4. A method according to claim 1, wherein a technology for mitigating interference used by the cluster controller is comprising beam forming and/or power control and/or spectrum avoidance.

5. A method according to claim 1, wherein the cluster controller is comprising the functionalities of Radio Resource Management (RRM) and/or traffic control and/or handover within the cluster and/or handover between cluster and main network and/or other radio network.

6. A method according to claim 1, wherein the cluster controller—preferably periodically—sends an information and/or a report request to at least one of the base stations.

7. A method according to claim 1, wherein the base station or base stations perform a measurement on its radio channel or channels for obtaining channel quality information, preferably SINR (Signal-to-Noise plus Interference Ratio).

8. A method according to claim 1, wherein the base station or base stations send the measurement information and/or report to the cluster controller.

9. A method according to claim 1, wherein the base station or base stations send frequency reuse parameters to the cluster controller.

10. A method according to claim 8, wherein the cluster controller allocates resource to the base station or base stations based on the received information and/or report.

11. A method according to claim 10, wherein the cluster controller informs the base stations about the allocated resource.

12. A network, preferably for carrying out the method according to claim 1, wherein a number of base stations are grouped into a cluster and are connected to a cluster controller and wherein the cluster controller is designed for providing access of the base stations to a main network, characterized in that the cluster controller is comprising means for mitigating interference within and/or outside the cluster on the basis of a measurement information and/or report from at least one base station.

13. A network according to claim 12, wherein the cluster controller is collocated with a gateway, preferably femtocell gateway, for providing access of the base stations to the main network.

14. A network according to claim 12, wherein a number of cluster controllers is connected to one gateway, preferably femtocell gateway.

15. A network according to claim 12, wherein the network is realized in a preferably large corporation deployment or in a high-density residential deployment area.

16. A network according to claim 12, wherein the base stations are connected to the cluster controller via logical connections or via VPN (Virtual Private Network).
